(19) United States
(12) Patent Application Publication
(10) Pub. No.: US 2016/0224979 A1
(43) Pub. Date: Aug. 4, 2016

(54) System and Method for Encryption of Financial Transactions Using One-Time Keys (Transaction Pad Encryption)

(71) Applicant: Pocket Systems, Inc., Woodside, CA (US)

(72) Inventor: David John MARSYLA, Woodside, CA (US)

(73) Assignee: Pocket Systems, Inc.

(21) Appl. No.: 14/613,224

(22) Filed: Feb. 3, 2015

(51) Int. Cl. G06Q 20/38

(52) U.S. Cl. CPC G06Q 20/3829; G06Q 2220/00

(57) ABSTRACT

The techniques used for encryption of financial transaction information using a modified One Time Pad encryption are disclosed to enable a system where financial transaction data can no longer be stolen from a merchant's computer system and re-used in a fraudulent manner. In order to ensure that stolen data cannot be reused, the strongest form of encryption is necessary and special considerations need to be made for cases where a thief may know some or all of the contents of the transaction message and seeks to reveal the encryption key and modify the transaction. This encryption technique is referred to as Transaction Pad Encryption, and can be used to replace existing methods of encrypting financial transaction information both in transit and while stored in a merchant data system.

### FIELD OF THE INVENTION

Embodiments of the present invention relate to the field of secure financial transactions, and more particularly, to a small, personal hardware device for encrypting financial transaction data.

### BACKGROUND OF THE INVENTION

It is widely understood that theft of consumer credit card information is a growing and expensive problem in society. Many attempts have been made to secure or obscure the transfer of customer financial information, but most approaches have proven to be easily defeated by determined hackers, resulting in high costs to financial institutions and consumers alike.

Current approaches to address this problem have largely focused on improving security controls at point of sale terminals, across networks, or inside of merchant information systems in order to prevent information from being stolen.

These current approaches however, have failed to make significant impact in stopping the theft of credit card information, and the problem has grown to the point where billions of dollars are being lost annually.

Therefore, we must assume that financial information can, and will be stolen, and so there is a need to create a new technique for encrypting the details of a financial transaction that is so secure, it is impossible to break, even in the event that the information has been stolen.

Creating an unbreakable method of encrypting credit card and transaction information as it travels through the financial system can finally eliminate the problem of credit card number theft. If there is no value to a thief from stealing the information, then they will eventually stop trying.

### SUMMARY OF THE INVENTION

The present invention provides a means for encrypting the terms and payment information for a financial transaction using a modified version of One Time Pad encryption.

One Time Pad encryption is the approach of using a unique, randomly generated encryption key to encode each message. Each random key must be equal to, or larger than the amount of data being encrypted, and the key must be held only by the parties authorized to encrypt and decrypt the message. Each key is discarded after one time use. As long as the unique key is truly random, the encryption approach is provably unbreakable, and no party without the key can decrypt the message.

Although the One Time Pad is one of the simplest and oldest forms of encryption, it is rarely employed because the need to distribute unique keys for each message limits the amount of information that can be encrypted with this approach.

Financial transactions, however, are an ideal application of One Time Pad encryption. The data needed to uniquely represent a single transaction is relatively small (generally less than 256 bits), and consumer financial transactions are done infrequently (generally fewer than 100 transactions/month).

A small personal computing device, with non-volatile memory storage, can easily hold more than 1,000,000-256 bit random keys. Enough for a lifetime of encrypted financial transactions for a single customer.

The simplest embodiment of One Time Pad encryption is, however, insufficient for encrypting financial data, and so an improved method of encryption is required. The improved method must preserve the benefits of unbreakable encryption provided by the One Time Pad while addressing the specific challenges of encrypting financial information.

The reason a different approach is needed for financial transactions is that the underlying information in a financial transaction is often partially or fully known to the person attempting to steal the information. In this case, the thief's goal is not to retrieve the information, but to decode it, revealing the encryption key, and modifying the information to their own benefit.

In a simple embodiment of One Time Pad encryption, each character of the pad (or random key) is added or exclusive or'd (XOR) with a single plain text character of a message. If the plain text message is not known, there is absolutely no way for it to be derived from the encrypted text without the key.

In financial transactions, we must assume that part, or all, of the message is known, and so the simplest embodiment cannot be used. A thief who knows part of the original message, can reverse the process, identify part of the key, modify that part of the message, and re-encrypt it.

To prevent this, we must create an algorithm to scramble the encrypted information in such a way that even if part, or all of the underlying plain text is known, the location of each piece of information is not known, and so a thief without the decryption key would have no ability to identify which part of the message should be decrypted and modified, and would have no ability to correctly re-encrypt the message.

This modified version of the standard One Time Pad can result in a means of encrypting transaction data in a manner than cannot be broken. This modified version will be referred to as Transaction Pad Encryption.

Although this algorithm is designed for the specialized case of encrypting financial information, it can be applied to any general case where an encryption key is being used to encode underlying data that is already known. For example, the same algorithm can be used to encrypt an empty data set (all zeros), or for encrypting a known private key, without revealing the key that was used for encryption.

### BRIEF DESCRIPTION OF THE DRAWINGS

FIG. 1 is a flow diagram of an exemplary Financial Transaction Data Flow according to some embodiments of this invention.

FIG. 2 is a data diagram of an exemplary Financial Transaction Encryption Data according to some embodiments of this invention.

FIG. 3 is a data diagram of an exemplary Encryption Key States according to some embodiments of this invention.

FIG. 4 is a flow diagram of an exemplary Encrypted Data Scramble Process according to some embodiments of this invention.

FIG. 5 is an embodiment of a Secure Device for performing the methods of FIGS. 1-4.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention may be practiced. It is to be understood that other embodiments may be used and structural changes may be made without departing from the scope of the preferred embodiments of the present invention.

Embodiments of the present invention are directed to encrypting financial transaction information using techniques that make it impossible to be decrypted or modified by anyone but a designated authority (the Key Authority). Typically the Key Authority would be a card issuing bank, or a credit card network, but it could be any other trusted authority.

### Financial Transaction Data Flow

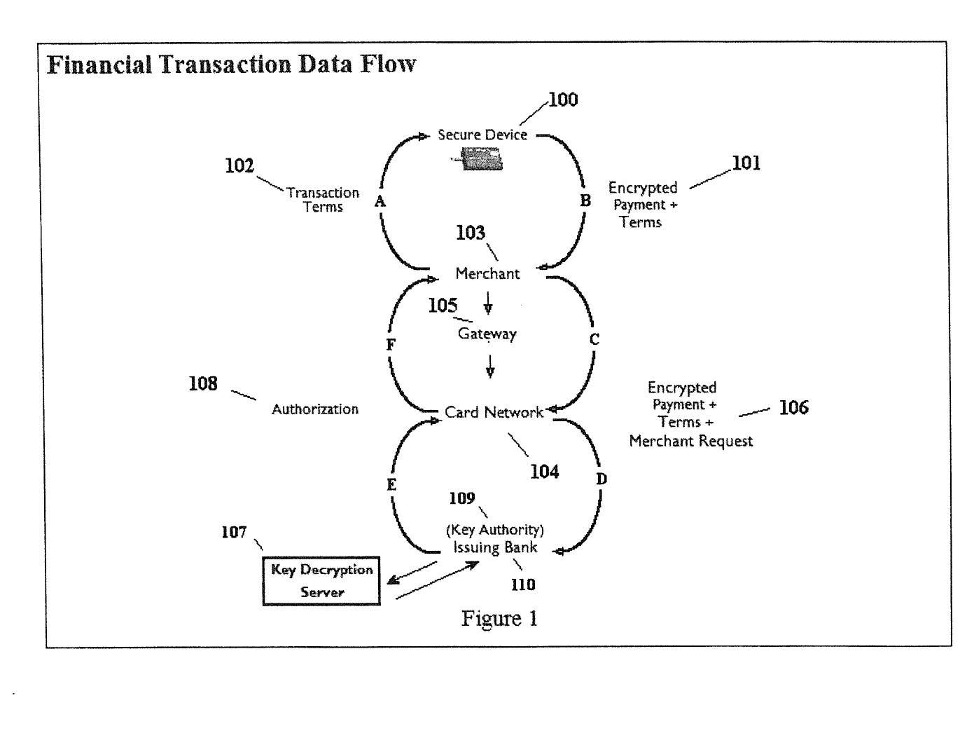

FIG. 1 is a flow diagram of the exchange of information in this type of financial transaction. The purpose of this data flow is to provide encrypted payment information from a customer to an issuing bank (e.g. Wells Fargo, Chase, . . . ) through the traditional merchant gateways (e.g. Authorize.net) and card networks (e.g. Visa, MasterCard, . . . ) in a format that cannot be intercepted or modified while the data is in transit, or while the data is stored in a merchant computer system.

FIG. 1 illustrates some key elements of the flow that are important to illustrating the types of information that are included in the encrypted financial message, and who has the ability to decrypt it.

The process begins when a Merchant 103 requests payment information from a customer, who in this case is the owner of a Secure Device 100 that will be used to encrypt the transaction. The Merchant 103 could be a point of sale terminal at a physical store, or could be a web site shopping cart for processing an online transaction.

In the preferred embodiment of the invention, the Transaction Terms 102 are passed from the Merchant 103 when the payment information is being requested (step A). The Transaction Terms 102 at least includes an identification of the Merchant 103 and the amount to pay. This allows the Secure Device 100 to include the payment terms with the encrypted payment information.

It is important that Transaction Terms 102 are included within the encrypted message so that the single message describes the complete scope of the transaction as a single, unbreakable unit.

For purposes of this description, the exact set of Transaction Terms 102 that are used, and the format of the information is not important, as long as it at least includes a method of identifying the merchant, and the amount of the agreed upon transaction. The terms will often include other information such as currency being used and whether the transaction is one-time or recurring in nature.

Thereafter, Secure Device 100 generates Encrypted Message 101 (step B), which includes Transaction Terms 102 and other information in encrypted form. In some embodiments of the invention, an actual customer identifier is included within Encrypted Message 101, the encrypted message, but often this is not necessary because the public identifier for the Secure Device is enough information to derive which customer account the transaction is to be applied.

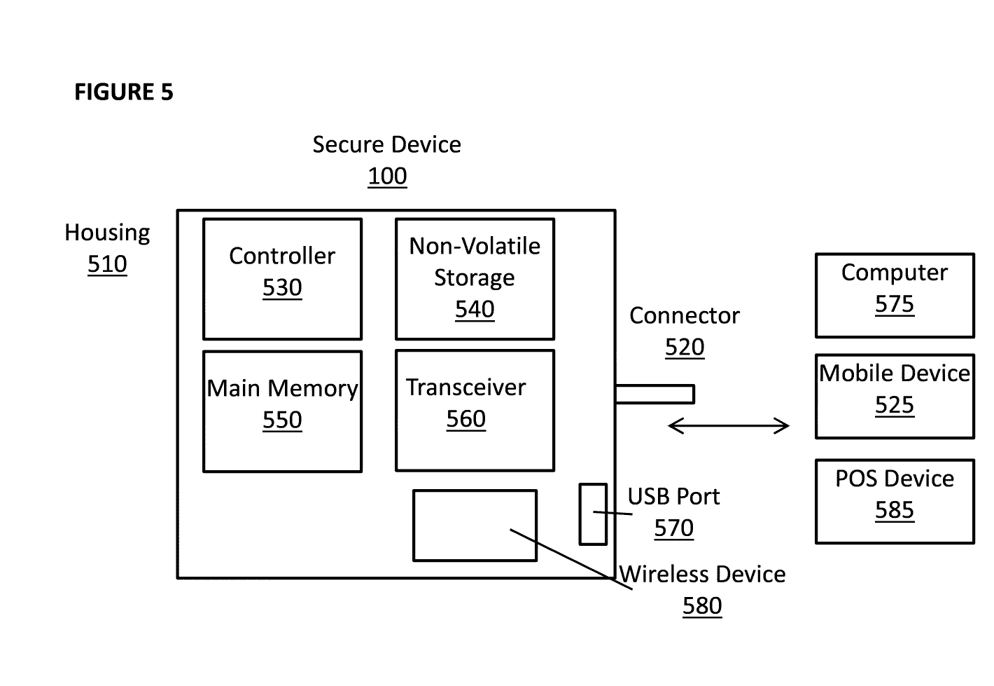

With reference to FIGS. 1 and 5, Secure Device 100 transmits Encrypted Message 101 (step B) to Merchant 103 using one of a variety of different mechanisms. First, Security Device 100 can connect to Computing Device 575 (such as a desktop, notebook, or tablet computer) using a standard USB cable over USB Port 570, and can then exchange information with software embedded in a Merchant 103's web site. The exchange can be done by encoding the communication using signals sent over a digital audio speaker or microphone connection, or by encoding the data using generated keyboard events. The web application on the computing device is then responsible for sending the encrypted payment information to Merchant 103 over an internet connection.

Second, if Merchant 103 has provided a mobile application that allows purchases to be made, Secure Device 100 will communicate with software embedded within the mobile application to send and receive information over Connector 520 and the audio port of Mobile Device 525. The mobile application on Mobile Device 525 is then responsible for forwarding the encrypted payment information to Merchant 103 using an internet connection from Mobile Device 525.

Third, if Merchant 103 has a Point-of-Sale Terminal 585, Secure Device 100 will communicate with the Terminal 585 using a wireless protocol such as WiFi, Bluetooth, or near-field communication (NFC) and Wireless Device 580 and will exchange information with Terminal 585, and Terminal 585 then will pass the encrypted payment information to Merchant 103's internal systems.

With reference again to FIG. 1, the Encrypted Message 101 is combined with a merchant request and sent as Encrypted Message and Merchant Message 102 (which comprises Encrypted Message 101 plus additional merchant information) from Merchant 103 through Gateway 105 to Card Network 104 (Step C) and finally to Issuing Bank 110 (Step D), which in this example is Key Authority 109. Issuing Bank 110 uses Key Decryption Server 107 to decrypt the Encrypted Message and Merchant Message 102.

Issuing Bank 110 then sends confirmation to Merchant 103 through Card Network 104 (Step E) and Gateway 105 (step F).

The other key point to this transaction flow is that the Secure Device 100 holds the pre-loaded One Time Pad key needed to encrypt the information, and the Key Authority 109, which is typically the Issuing Bank 110 (e.g. Wells Fargo, Chase, . . . ), is the only other party who holds the decryption key. No other system or party that the information flows through has the ability to decrypt or modify the transaction.

In some embodiments of this transaction flow, the Card Network 104 (e.g. Visa, Mastercard, . . . ) acts as the Key Authority 109 instead of the Issuing Bank 110. This can simplify the deployment, but leaves the customer information in an unencrypted state during part of its journey through the transaction. As long as the communication between the Card Network 104 and Issuing Bank 110 is deemed secure, this embodiment would be equally desirable.

FIG. 5 depicts components of Secure Device 100. Secure Device 100 comprises Housing 510, Connector 520, Controller 530, Non-Volatile Storage 540, Main Memory 550, Transceiver 560, USB Port 570, and Wireless Device 580. Housing 510 is a physical enclosure. Connector 520 connects Secure Device 100 to a computing device such as a Point-of-Sale device or a smartphone and can comprise, for example, an audio jack. Controller 530 is a processing unit that performs functions necessary for the methods described herein. Controller 530 utilizes Main Memory 550 during operation, such as to store instructions and data. Non-Volatile Store 540 can comprise flash memory, a hard disk drive, or other media, and can be used to store the One Time Pad key. USB Port 570 is a port for connecting to a standard USB cable. Wireless Device 580 is a device for engaging in wireless communication with another device, such as by using WiFi, Bluetooth, or NFC (Near Field Communication). Transceiver 560 communicates with external devices using Connector 520, USB Port 570, and/or Wireless Device 580.

### Financial Transaction Encryption Data

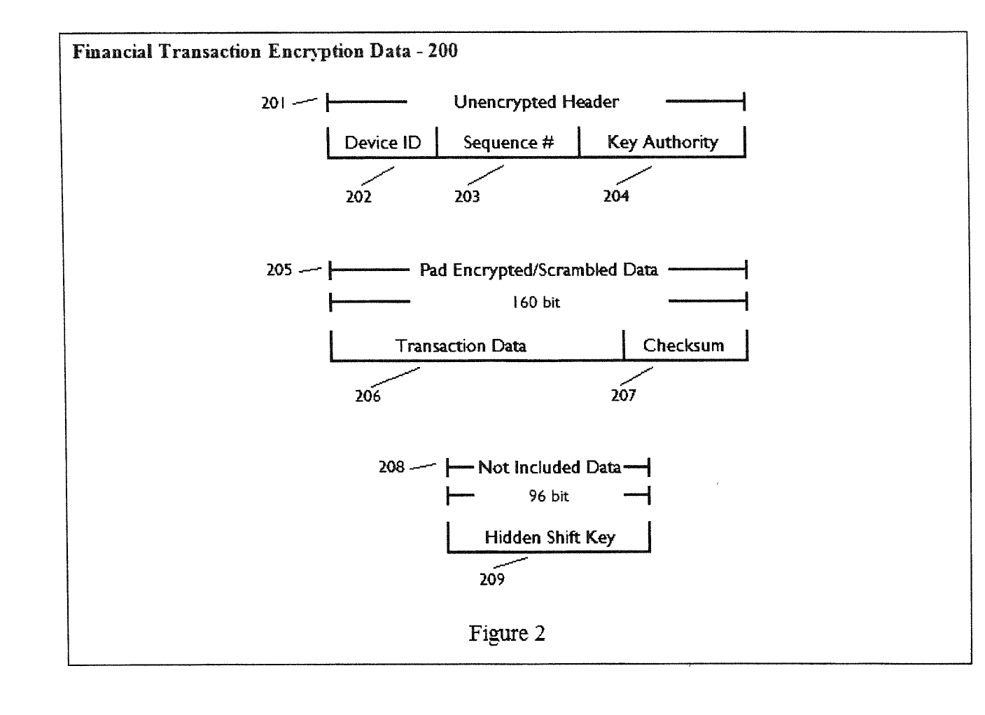

FIG. 2 is a block diagram of the preferred embodiment of the structure of the Financial Transaction Encrypted Data 200, which is an example of Encrypted Message 101 in FIG. 1. In this example, the size of the Pad Encrypted Data 205 is 160 bits, the size of the Transaction Data 206 is 160 bits, the Checksum 207 is 32 bits, and the Hidden Shift Key 209 is 96 bits. These sizes are only used for illustration purposes, and a wide range of smaller or larger data sizes, or different ratios of sizes between the elements would be equally effective for implementing the encryption algorithm.

Associated with each Financial Transaction Encrypted Data 200 message, is an Unencrypted Header 201. The header is necessary to communicate which of the large number of pre-loaded keys was used to encrypt the data. The Key Authority 109 will use this information to decrypt the transaction.

The Unencrypted Header 201 contains three pieces of important information. The Device ID 202 is a globally unique identifier which is used to identify the Secure Device 100 that was used to encrypt the transaction. This identifier can be public information and does not give a thief any useful information about the transaction.

The Sequence #203 is used to communicate which pre-loaded key inside of the device was used for the encryption. There may be cases where the key number is not provided, and in this case, the Key Authority 109 must assume that the key which was used is the next one in the series of pre-loaded keys.

The Key Authority 204 is usually a one or two character code to identify which Key Authority 109 has the responsibility for decrypting the message. There may be cases where this is not provided, and the information is derived from other sources, such as a Device ID 202 that is bound to a single Key Authority 109, or a tokenized customer account number that is used to route to the transaction.

The Pad Encrypted/Scrambled Data 205 is where the actual transaction information (merchant, payment terms) is contained. As will be described in detail, a 160 bit random key is used to encrypt the Transaction Data 206 and to encrypt a Checksum 207. The Checksum 207 is a hash, or digest, of the Transaction Data 206 and provides a mechanism for detecting any unauthorized modification of the Transaction Data 206.

The Checksum 207 that is included with the message is only part of a larger checksum, typically 32-bits of a 128-bit MD5 digest hash of the transaction data. A small part of the Hidden Shift Key 209 is used to determine which 32-bit subset of the full 128-bit checksum is actually included in the message. In a typical embodiment, the first 7 bits of the Hidden Shift Key can define a value between 0-127 to indicate the first bit of the 128-bit checksum to include. The next 31 adjacent bits are also included with the message.

Having only part of the checksum available is preferable over having the entire checksum since it creates one more level of uncertainty for someone who knows the content of the message but does not know which part a the checksum was included. In this embodiment of the algorithm, an MD5 digest is used, but practically any hash, checksum or digest could be used to provide a similar level of security for the data format. Smaller or larger sizes could also be used without meaningfully impacting the security, although the larger the included checksum, the more likely it is to detect attempts to tamper with the message.

The Not Included Data 208 is unique to this method of scrambling the order of the Pad Encrypted 205 data. This contains a Hidden Shift Key 209 that is known to both the device encrypting the message, and to the Key Authority 109 who decrypts the message, but is not sent along with the message (hence the name not included data). Having part of the encryption key not included in the data itself, creates another barrier to someone who knows the message content but cannot know the hidden key.

### Example Encryption Key States

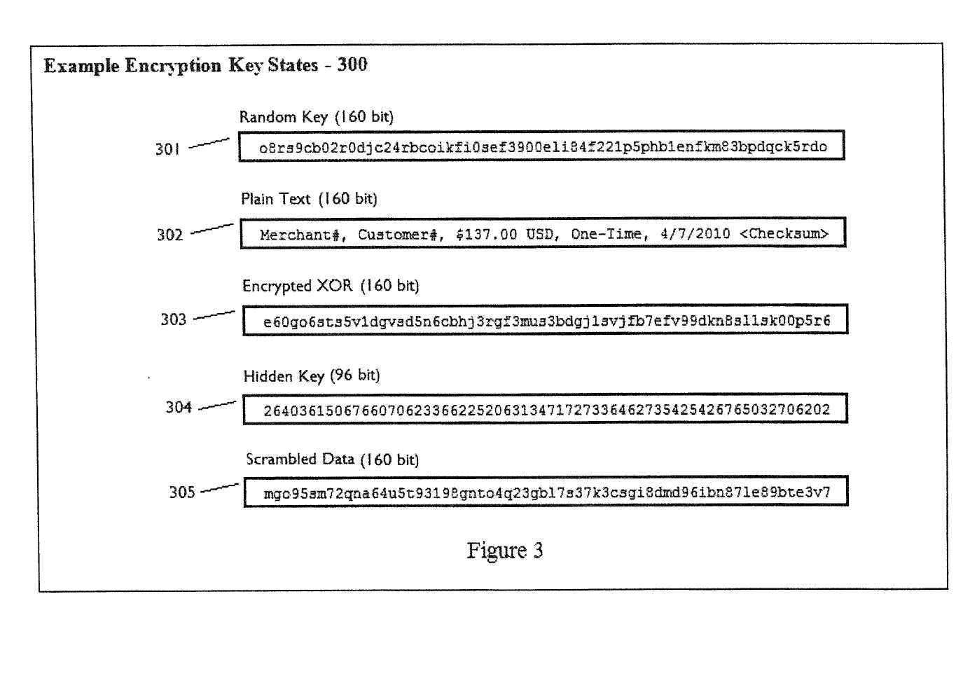

FIG. 3 is an example diagram of the preferred embodiment of the structure of information used in various Encryption Key States 300. Note that the actual example keys and plain text shown in FIG. 3 are intended for illustration only, and are not the actual keys or text that would be used in a typical embodiment.

In the Example Encryption Key States 300, the Random Key 301 is shown in a readable format where each character within the key is represented by numbers and lower case letters for a total of 32 possible values, which can be stored as 5-bits of information. Again, this is simply for illustration, and a 5-bit, 6-bit, or any other number of bits per character in the message could be used without changing the algorithm.

The Plain Text 302 is shown in a readable format, and is assumed that each character in the Plain Text 302 can be represented by 5-bits of information to match the Random Key 301.

The first step of the encryption process is to take the Random Key 301 and apply it to the Plain Text 302 using some sort of simple, reversible method. The preferred embodiment of this is to iterate over each 5-bit character from the Random Key 301 and the corresponding 5-bit character from the Plain Text 302 and perform and exclusive or operation (XOR) of the two characters to obtain a resulting character as shown by the Encrypted XOR 303 in the example.

It is also possible to use addition, subtraction, or other reversible operations to generate the pad Encrypted key 303. It is also possible, and perhaps more efficient to operate on more than 5-bits at a time, but the amount of data being operated on does not change the logical result being generated.

To reverse the encoding of the information from this point, the same Random Key 301 is exclusive or'd with the Encrypted XOR 303 format, and the result will be the Plain Text 302 that we started with.

At this point, the algorithm has not departed from a standard One Time Pad Encryption, but the resulting encrypted message has the weaknesses identified in the summary of the invention, and is insufficient for the type of security desired.

To resolve the insufficiencies of the Encrypted XOR 303 format, the data must be further scrambled in such a way as to make it impossible to predict where any particular part of the plain text message will appear within the encrypted message.

To do this, we employ the use of a Hidden Key 304 which will be used along with the original Random Key 301 to scramble the data. It is important that the Hidden Key 304 is not actually included in the encrypted message to prevent decryption of the message by someone who knows the complete plain text message, and desires to derive the key. Hiding part of the key helps to prevent this.

The Hidden Key 304 is typically smaller than the Random Key 301, but it could also be the same size or larger. Having a larger Hidden Key 304 will not practically improve the strength of the encryption because the current size is already sufficient to make it impossible to decrypt the data and reveal the underlying key.

The Scrambled Data 305 is an example result of the process of using the Hidden Key 304 and Random Key 301 to scramble the Encrypted XOR 303 information. The Scrambled Data 305 is now in a format that is impossible to decrypt without access to the original decryption key.

The only method that could be employed to try and decrypt data in the Scrambled Data 305 format would be to attempt to guess the complete 256-bit key (the combined size of the 96-bit and 160-bit keys). Even if someone tried to guess the complete key, and the guessed key resulted in correctly decrypted data, they would have no way of knowing if they had chosen the actual key that could be used to modify and re-encrypt the information.

### Encrypted Data Scramble Process

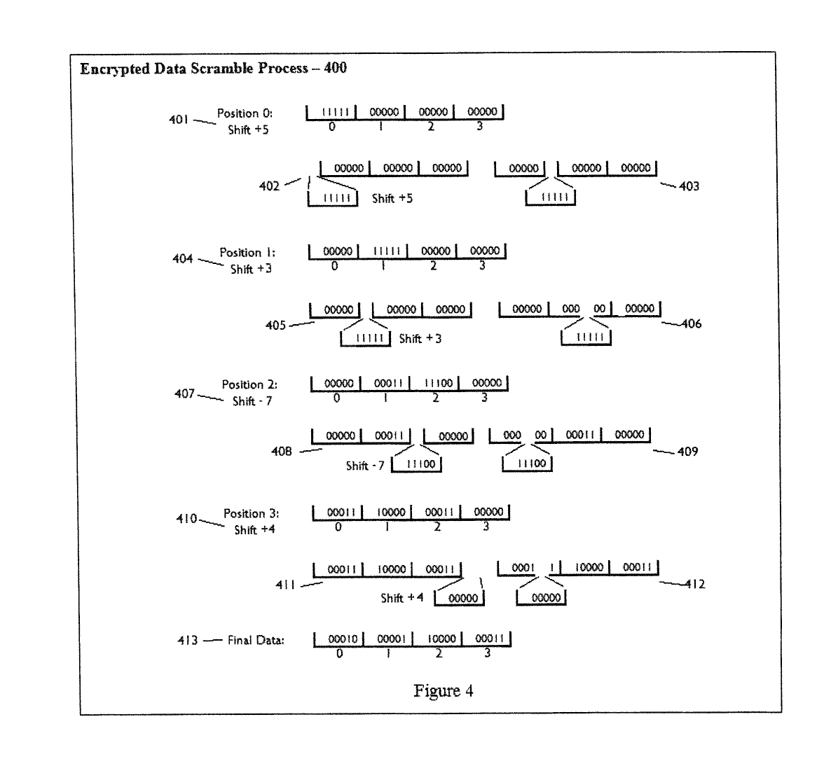

FIG. 4 is an example diagram of the preferred embodiment of the process used to scramble the Encrypted XOR 303 data to create the Scrambled Data 305. Although many different algorithms could be used to scramble the data, the procedure described is sufficient to make the Scrambled Data 305 impossible to decrypt, and so any enhancements or modifications to the algorithm would not improve the security of the information and would not be an improvement over the described embodiment. The algorithm described is also simple to implement in even the most restricted computing environments and any improvement on efficiency would not be an improvement for where the algorithm could be practically implemented.

The Encrypted Data Scramble Process 400 is shown using simple data, and small shift values to help explain the algorithm. Typically, the information being encrypted is much larger (e.g. 160 bits as shown in FIG. 3) and the shift amounts are anywhere from −128 to +128 bit positions.

To start the process of scrambling the data, we must first determine the amount that each character in our Encrypted XOR 303 data is going to be shifted. We do this by combining 3-bits from our Hidden Key 304, with 5-bits from our Random Key 301. We could combine these in many ways but since the data is all random, it does not particularly matter how they are combined. However, there may be a slight advantage in using 3-bits from our Hidden Key 304 as the most significant bits in our combined value.

If our Hidden Key 304 is large enough, it may not be necessary to combine it with part of our Random Key 301, but as long as a combined key is sufficient so that any single bit of unscrambled data is equally likely to appear in any position of scrambled data, there is no value in creating a larger hidden key.

Once we have combined our Hidden Key 304 and our Random Key 301, we have 8-bits of random data that we can use for scrambling each character of our Encrypted XOR 303 data. We use this 8-bits of information to determine a bit shift amount for each character, in either the positive or negative direction. With 8-bits of information, we use a range of −128 to +128 and assume we never want to have a zero shift. If our shift goes beyond the boundaries of our Encrypted XOR 303 data (which is only 160 bits long), we wrap around to the other side of the data.

Although we have chosen a range of −128 to +128, practically any range could be used to get the same effect. In our example, our encrypted text is only 160 bytes, so a range of more than +80 or −80 is not necessary. Also a range of −64 to +192, or 0 to 255 would generate equally difficult results to decrypt. Using a dynamic range based on part of the hidden key may also be done, but in the end will not make the data any more secure than the present embodiment.

Now that we have determined a shift amount for each character in our Encrypted XOR 303, we iterate over the characters one at a time, removing the 5-bit character from the data and shifting it to another location left or right (negative or positive) by up to 128 bits in either direction.

In our example in FIG. 4, the first position of our example data, Position 0-401 represents the starting point, or the format of our Encrypted XOR 303 data. In the example of Position 0-401, we used our hidden and random keys to determine we should shift the first character by 5 bits to the right (a shift of +5).

We simply remove the first character, and re-insert it into our data shifted 5 bits over. The removal is show by example 402, and re-insertion is shown by example 403.

In the second step of our Encrypted Data Scramble Process 400, we move to Position 1-404, and repeat the process with the data found at that position, using the corresponding 8-bit shift value derived from combining 3-bits of Hidden Key 304 at position 1, and 5-bits of Random Key 301 at position 1. In this example, we determine that this gives us a shift of 3 to the right (a shift of +3).

Note that in this case, we coincidentally remove and shift the same data that had been shifted in step 1 of the process. This is shown by example 405 and example 406. This is perfectly legitimate and part of our goal is to allow for multiple shifts of the same information to increase the randomness of where each bit of information eventually ends up in our final Scrambled Data 305.

The process continues with every character in our data, each using a different 8-bit combined hidden and random key. In the example of Position 3-410, our shift goes beyond the end of the data, and so wraps around to the start as shown in example 412.

After each position has been processed, we end with our Final Data 413 which is now in the format of our Scrambled Data 305. Note that even with a very simple example, the original bits of our encrypted data have been shifted into largely unrecognizable patterns.

To reverse this process during the decryption phase, we simply iterate backwards from the last character to the first, and perform the shift in the opposite direction as indicated by our hidden and random key. When shifting in reverse, we remove the data from the position indicated, and replace the data at the character we are processing.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

1. A method for performing a secure financial transaction, comprising:
receiving, by a first computing device, transaction terms from a second computing device, the transaction terms comprising a merchant identifier, a customer identifier, and a transaction amount;
encoding the transaction terms in a format using a fixed number of bits to generate encoded transaction terms;
encrypting, by the first computing device, the encoded transaction terms to generate an encrypted message, wherein the encrypting comprises using a one-time use encryption key that contains a larger number of bits than the encoded transaction terms; and
sending, by the first computing device, the encrypted message to a third computing device comprising a storage device containing the one-time use encryption key.

2. The method of claim 1, wherein the second computing device is a point-of-sale device.

3. The method of claim 2, wherein the third computing device is a server.

4. The method of claim 1, wherein the encrypted message also contains a random sub-section of a checksum generated from the encoded transaction terms, and wherein information about which part of the checksum is included is not contained within the encrypted message.

5. The method of claim 1, further comprising sending, by the first computing device, a header with the encrypted message.

6. The method of claim 5, wherein the header comprises a unique identifier for the first computing device, a sequence number that identifies which key is used for the encryption, and an identifier for the third computing device.

7-9. (canceled)

10. A device for encrypting financial transaction information, comprising:
a housing;
a connector;
a controller within the housing; and
non-volatile storage within the housing and coupled to the controller, the non-volatile storage storing a plurality of one-time use encryption keys;
wherein the controller is configured to receive transaction terms to and generate an encrypted message using the transaction terms and one of the plurality of encryption keys, while ensuring that the one of the plurality of encryption keys has not been used previously by the device to generate an encrypted message.

11. The device of claim 10, wherein the connector comprises an audio connector.

12. The device of claim 10, wherein the non-volatile storage comprises flash memory.

13. The device of claim 10, wherein the one of the plurality of encryption keys comprises a portion that is never transmitted outside of the device.

14. The device of claim 10, wherein the transaction terms comprise a merchant identifier, a credit card number, and a transaction amount.

15. The device of claim 10, wherein the encrypted message further comprises an unencrypted header.

16. The device of claim 15, wherein the unencrypted header comprises a unique identifier for the first device, a sequence number to identify which key is used for the encryption, an identifier for the device that can decrypt the encrypted message.

17. The device of claim 10, wherein the encrypted message does not contain the entire encryption key.

18. A device for decrypting financial transaction information, comprising:
a server configured to decrypt a received encrypted message using an encryption key comprising a first part and a second part, the first part contained in the encrypted message and the second part stored in the server and not contained in the encrypted message.

19. The device of claim 18, wherein the encrypted message comprises a merchant identifier, a credit card number, and a transaction amount.

20. The device of claim 18, wherein the encrypted message is received by the server from a credit card network.
